(19) United States
(12) Patent Application Publication
(10) Pub. No.: US 2006/0234201 A1
(43) Pub. Date: Oct. 19, 2006

(54) System and method for adaptive electronic-based learning programs

(75) Inventors: Donald Charles Pierson III, Phoenix, AZ (US); Robert L. Harner, Tempe, AZ (US)

Correspondence Address: QUARLES & BRADY LLP, RENAISSANCE ONE, TWO NORTH CENTRAL AVENUE, PHOENIX, AZ, 85004-2391, US

(73) Assignee: Interactive Alchemy, Inc.

(21) Appl. No.: 11/407,541

(22) Filed: Apr. 19, 2006

Related U.S. Application Data
(60) Provisional application No. 60/673,144, filed on Apr. 19, 2005.

(51) Int. Cl. G09B 7/00

(52) U.S. Cl. 434/323; 434/362

(57) ABSTRACT

In an electronic learning program, a training program is provided to convey information to a user. The training program uses sequences and measures within the sequences to organize the course material to be presented. An assessment of the user is performed prior to formal training. The assessment tests for attitude and knowledge base of the user. The attitude assessment solicits responses from each user as to state of mind regarding the training program. The knowledge assessment solicits responses from each user to test understanding of the course material. The training program is adapted under a rule structure based on the assessment to alter presentation of the training program. A first or second measure is selected for presentation to the user based on a rule check of the user assessment. The first measure is a different level of detail than the second measure of similar subject matter.

### CLAIM TO DOMESTIC PRIORITY

The present non-provisional patent application claims priority to provisional application Ser. No. 60/673,144 entitled “E-Learning System,” filed on Apr. 19, 2005.

### FIELD OF THE INVENTION

The present invention relates in general to electronic learning systems and, more particularly, to a system and method of creating electronic learning programs for ease of development and effectiveness for the end user.

### BACKGROUND OF THE INVENTION

Electronic learning (e-learning) has been used for many years as a tool for training and general dissemination of information. Corporations, governments, and educators have all made use of e-learning in their continuing education programs. For example, a company with a new employee orientation program or a new product release could provide the information to employees or customers through a computer system running an e-learning tool. Each person could view the training program during a convenient time at his or her own pace.

Most e-learning systems are computer-based or web-based. In a computer-based system, the e-learning program is downloaded from compact disc (CD) or other transportable medium to the computer hard drive. The e-learning program executes directly on the computer for the benefit of the user. Computer-based e-learning is typically fast and can be visually interesting to the user, but can become outdated as the system being learned evolves. In web-based systems, the user's computer is connected to a remote system over a modem or other communication medium. Although web-based e-learning programs are generally more up-to-date, such media can suffer slow response from the massive amounts of graphics and text which must be transmitted over the communication network.

The typical content of an e-learning program includes graphics, text, video, and audio. The program developer puts the e-learning program together from his or her own experience and information gathered from subject matter experts and anticipates the needs of most users. Most software development tools are limited to making program-specific modifications to boiler-plate modules and organizing the modules to best present the overall program to the average user. However, these e-learning development tools do very little in terms of simplifying the program development process or real-time interaction with the user.

The user reads the text, views the graphics, and listens to the audio to receive the relevant information. Yet, many e-learning programs are only marginally effective. A company typically chooses between developing its own custom e-learning tool or buying an off-the-shelf program. Custom e-learning programs are often costly to produce and may require skills that the company does not have, in which case, the company may need to engage an outside vendor. The off-the-shelf program may not convey the desired message in the manner envisioned by the company. Nonetheless, e-learning providers continue to produce large libraries of canned programs, which are not necessarily attuned to the real needs of the end users.

Many users learn at different paces and come to the e-learning program with different skill sets and experience levels. Yet, most e-learning courses provide the same information to everyone, with little or no opportunity to adjust or customize the presentation. While some courses allow the user to select specific chapters or sections for viewing, all users still see the same information—at least for those sections that are selected and viewed. There is little or no customization within the e-learning tool to take into account what the user already knows, or how he or she might best learn the information.

In addition, most e-learning tools are created without regard to the unique way humans learn. Research has shown that the human brain copes with the immense amount of information it is constantly receiving by filtering it and searching for recognizable patterns within the information. Information that is in accordance with such patterns is accepted; information not in accordance with a pattern, or seemingly random, is ignored. As patterns reoccur, they are reinforced and become further ingrained. In addition, the brain constantly searches for that which has changed. For example, a person will learn to ignore common background sounds such as the hum of an air conditioner. However, a sudden change in the pitch of the hum will immediately attract the person's attention. Further, the human brain's receptiveness to information is influenced by emotional arousal. That is, a human who is emotionally engaged will be more receptive to information than one who is bored. Thus, to be truly effective, e-learning tools must be designed in such a way as to both establish recognizable patterns and vary key attributes in non-random ways so that the user's attention will be maintained.

A need exists for an e-learning tool that is easier to develop and more effective in conveying information to users.

### SUMMARY OF THE INVENTION

In one embodiment, the present invention is a method of providing an electronic learning program comprising the steps of providing a training program to convey information to users, performing an assessment of each user for attitude and knowledge base prior to participation in the training program, and adapting the training program based on the assessment to alter the electronic learning for benefit of the user.

In another embodiment, the present invention is a method of adapting presentation of an electronic learning program comprising the steps of providing a training program to convey information to a user, performing an assessment of the user, and adapting the training program based on the assessment to alter presentation of the training program for benefit of the user.

In another embodiment, the present invention is a computer program product usable with a programmable computer processor having a computer readable program code embodied therein comprising computer readable program code which provides a training program to convey information to a user, performs an assessment of the user, and adapts the training program based on the assessment to alter presentation of the training program for benefit of the user.

In another embodiment, the present invention is a computer system for adapting presentation of an electronic learning program comprising means for providing a training program to convey information to a user, means for performing an assessment of the user, and means for adapting the training program based on the assessment to alter presentation of the training program for benefit of the user.

In another embodiment, the present invention is a method of developing an electronic learning program comprising the steps of providing a training program to convey information to a user, coding modules of the training program based on emotional content of the information as conveyed to the user, and spacing the modules of the training program based on the coding to balance impact of presentation of the information on the user.

### BRIEF DESCRIPTION OF THE DRAWINGS

FIG. 1 illustrates a process of developing, installing, and using an e-learning program;

FIG. 2 illustrates a computer system and network for operating the e-learning program;

FIG. 3 illustrates an assessment process for evaluating user attitude and knowledge base;

FIG. 4 illustrates a screen for soliciting responses to the user assessment in question and answer form;

FIG. 5 illustrates a screen for soliciting responses to the user assessment in statement form;

FIG. 6 illustrates a logical flow of the e-learning program;

FIG. 7 illustrates a logical flow of a lesson sequence from FIG. 6;

FIG. 8 illustrates the e-learning program making decisions on lesson sequences based on the user assessment;

FIG. 9 illustrates a first presentation measure selected based on the user assessment;

FIG. 10 illustrates a second presentation measure selected based on the user assessment; and

FIG. 11 illustrates a process flowchart of providing an electronic learning program.

### DETAILED DESCRIPTION OF THE DRAWINGS

The present invention is described in one or more embodiments in the following description with reference to the Figures, in which like numerals represent the same or similar elements. While the invention is described in terms of the best mode for achieving the invention's objectives, it will be appreciated by those skilled in the art that it is intended to cover alternatives, modifications, and equivalents as may be included within the spirit and scope of the invention as defined by the appended claims and their equivalents as supported by the following disclosure and drawings.

Electronic learning (e-learning) programs are an important and effective means of communicating new information and otherwise providing training to groups of people. For example, a company or firm may have a new software system, human resource training, employee orientation, product release, or corporate initiative that needs to be conveyed to its employees. While live instructor training has been the preferred method historically, the e-learning approach offers a number of advantages. The employees can receive the e-learning program at a convenient time and location and view the material at their own pace. The program can be easily repeated or rescheduled. In terms of overall cost, e-learning is often a more cost-effective option. The difficulty with e-learning has been a lack of interaction with the person viewing the program. The user typically cannot ask questions and it is difficult to accurately assess the user's retention or effectiveness of the knowledge transfer. There is little or no impact on the way the program interacts with the person. In many cases, either the person viewing the program loses focus because he or she becomes disinterested or already knows the material, or the person is not comprehending or retaining the conveyed information.

The present e-learning program offers certain advantages over prior systems. The program offers tools, feedback, and hierarchical modular approach to aid in its development. The program developer can use these assets to design the program in a shorter time and with lower cost. In addition, the program offers tools that enable the program developer to easily and cost-effectively establish recursive patterns around key themes as well as vary the program's pacing and emotional intensity levels so that the learner will be more receptive to the information being conveyed. The program also provides real-time assessment and feedback for the person viewing the program. The e-learning system is able to ascertain the mindset and knowledge base of the user and customize its presentation in real-time. The person does not have to view portions of the e-learning program that he or she already knows. Moreover, the system can customize the format of the presentation according to the sophistication of the user. The system is further able to test the effectiveness of the training.

To see the e-learning program in operation, consider the following example of such a program implemented for a company. In the present example, the company manufactures certain product lines and has typical departments, such as design, engineering, manufacturing, sales, finance, accounting, marketing, legal, safety, and management. Assume the company has a new software system that will track the design, development, manufacture, sales, and delivery of its product lines, i.e., a manufacturing tracking system. The employee base needs to learn how to use the software, but each department and individuals within each department, will have a different perspective and context of their use of the new system.

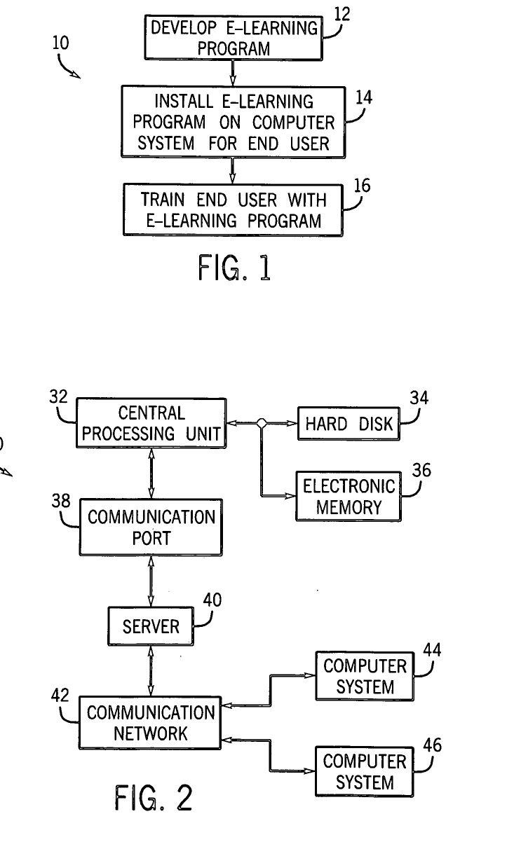

The e-learning program is developed to train all employees on their particular use of the new software system. FIG. 1 illustrates the general flow of e-learning program 10. In block 12, the e-learning program is developed by a program developer according to the needs of the end user—in this case the company and its employees. The development of the e-learning program uses a number of inventive features as described hereinafter. In block 14, the e-learning program is installed on the end user's computer system or made available to the user remotely. As such, the e-learning program is created as an application computer program, written in a conventional programming language, which runs on a computer system. The computer system is typically part of a larger network with connectivity to other computers, including one or more central servers, within the network. In block 16, the employees individually view and interact with the e-learning program. The interaction is adaptive and customized to the individual person viewing the program. The adaptive e-learning program will make the education process more enjoyable, convenient, efficient, and less burdensome. The user will retain more of the information conveyed by the program. The employees will benefit from the new skill set provided by the program. The cost effectiveness in terms of information transferred to and retained by the employee per dollar spent on the program is most favorable for the company. The following discussion addresses the system and process of developing and using the present e-learning system.

FIG. 2 illustrates a simplified computer system 30 for executing the software program used in the e-learning program 10. Computer system 30 is a general purpose computer including a central processing unit or microprocessor 32, mass storage device or hard disk 34, electronic memory 36, and communication port 38. Communication port 38 represents a modem, high-speed Ethernet link, or other electronic connection to transmit and receive input/output (I/O) data with respect to other computer systems.

Computer 30 is shown connected to server 40 by way of communication port 38, which in turn is connected to communication network 42. Server 40 operates as a system controller and includes mass storage devices, operating system, and communication links for interfacing with communication network 42. Communication network 42 can be a local and secure communication network such as an Ethernet network, global secure network, or open architecture such as the Internet. Computer systems 44 and 46 can be configured as shown for computer 30 or dedicated and secure data terminals. Computers 44 and 46 are also connected to communication network 42. Computers 30, 44, and 46 transmit and receive information and data over communication network 42.

When used as a standalone unit, computer 30 can be located in any convenient location. When used as part of a computer network, computers 30, 44, and 46 can be physically located in any location with access to a modem or communication link to network 42. For example, computer 30 can be located in e-learning host service provider's or administrator's main office. Computer 44 can be located in one department of the company, e.g., the sales office. Computer 46 can be located in another department of the company, e.g., on the production floor. Alternatively, the computers can be mobile and follow the users to any convenient location, e.g., remote offices, customer locations, hotel rooms, residences, vehicles, public places, or other locales with electronic access to communication network 42.

Each of the computers runs application software and computer programs, which can be used to display user interface screens, execute the functionality, and provide the features of the e-learning program as described hereinafter. In one embodiment, the screens and functionality come from the application software, i.e.,the e-learning program runs directly on one of the computer systems. Alternatively, the screens and functions are provided remotely from one or more websites on the Internet. In this case, the local computer is a portal to the e-learning program running on a remote computer. The websites are generally restricted access and require passwords or other authorization for accessibility. Communications through the website may be encrypted using secure encryption algorithms. Alternatively, the screens are accessible only on the secure private network, such as Virtual Private Network (VPN), with proper authorization.

The software is originally provided on computer readable media, such as compact disks (CDs), magnetic tape, or other mass storage medium. Alternatively, the software is downloaded from electronic links such as the host or vendor website. The software is installed onto the computer system hard drive 34 and/or electronic memory 36, and is accessed and controlled by the computer's operating system. Software updates are also electronically available on mass storage medium or downloadable from the host or vendor website. The software, as provided on the computer readable media or downloaded from electronic links, represents a computer program product usable with a programmable computer processor having a computer readable program code embodied therein. The software contains one or more programming modules, subroutines, computer links, and compilations of executable code which perform the functions of the e-learning program. The user interacts with the software via keyboard, mouse, voice recognition, and other user interface devices connected to the computer system.

The software stores information and data related to the e-learning program in a database or file structure located on any one of, or combination of, hard drives 34 of the computers 30, 44, 46, and/or server 40. More generally, the information used in the e-learning program can be stored on any mass storage device accessible to computers 30, 44, 46, and/or server 40. The mass storage device for storing the e-learning program may be part of a distributed computer system.

In the case of Internet-based websites, the interface screens are implemented as one or more webpages for receiving, viewing, and transmitting information related to the e-learning program. A host service provider may set up and administer the website from computer 30 or server 40 located in the host service provider's home office. The employee accesses the webpages from computers 44 and 46 via communication network 42.

In the present discussion, an e-learning program is developed for the multiple end users of the company, e.g., engineering, design, manufacturing, sales, finance, accounting, marketing, legal, safety, and management. For the present example, the e-learning program will be developed as one software application for all end users, although the e-learning program could be implemented in multiple software modules or applications, e.g., one for each major department.

To start the e-learning development process, the program developer must assess the features of the manufacturing tracking system as well as the needs of the users. The e-learning program developer may review the software manual or talk to the software developer or gain direct experience by using the manufacturing tracking system. The program developer creates a list or chart of features and information that should be presented to each type of user. The engineering department needs a first set of information to learn about features relevant to its operations and function; management needs a second set of information to learn about features relevant to its operation and function; manufacturing needs a third set of information to learn about features relevant to its operation and function; sales and marketing needs a fourth set of information to learn about features relevant to its operation and function; finance and accounting needs a fifth set of information to learn about features relevant to its operation and function; legal needs a sixth set of information to learn about features relevant to its operation and function; and so on. The e-learning program developer learns what needs to be conveyed to train the various employees on the manufacturing tracking system. The next step is creating the e-learning program that will most efficiently and effectively convey that information to each target end user.

An important feature of the e-learning program is its adaptive nature to individual learning styles. The training material must be presented with proper context for each user. As will be seen, the training program has the ability to adapt to the individual user, rather than forcing the user to adapt to the program. The e-learning program will deliver a course designed to address the strengths and weaknesses of the individual user. This feature represents a significant improvement over prior art e-learning systems, wherein the typical approach has been one program that fits all and each and every user is compelled to work his or her way through substantially the same course material.

The e-learning program is developed using a concept of sequences and measures. A sequence is an organizational environment or storage location in the computer system where the developer can place related sequences and specific measures. Sequences can be hierarchical in nature in that a sequence can contain related lower level or sub-sequences. Each lower level sequence can contain its own lower level or sub-sequences. A sequence is synonymous with a folder in a computer operating system. In the figures, a sequence is shown as a box. A measure is set of specific information that will be conveyed to the user. For example, a measure may contain one screen load of information with which the user interacts as part of a lesson. There are different types of measures within the e-learning program, such as title measure, clock measure, objective measure, menu measure, inspiration measure, presentation measure, research measure, discovery measure, impact measure, assessment measure, review measure, splash measure, game/puzzle measure, role play measure, illustration/application measure, simulation measure, survey measure, resource measure, transition measure and complete measure, each measure being organized and designed for a specific purposes within the training program. Each measure provides or supports one logical segment of course material to the user. A measure is akin to a file in a computer operating system. A measure is shown as a circle within the figures.

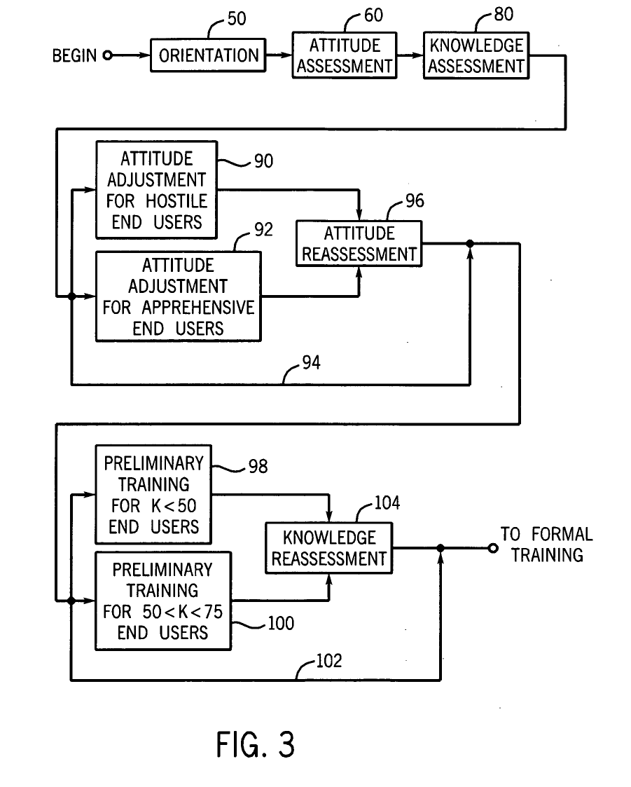

Turning to FIG. 3, the program developer begins with an orientation and one or more assessments of each user in order to determine user-based parameters such as demographics, attitude, state of mind, interest levels, present knowledge, competency, and experience.

Block 50 performs an orientation to gain basic personal and demographic information about the employee. The orientation may inquire into age range, nationality, gender, department within the company, job description, time in job, education, prior work experience, etc. A principal purpose of the orientation is to explain how the training program will proceed so the user can understand its purpose and benefit to the company and to his or her work function. The orientation is intended to get the interest level up, and to get the employee excited and focused on the upcoming training. The orientation will be one or more measures within one or more sequences and presented as one or more computer screens of graphics, text, video, and audio.

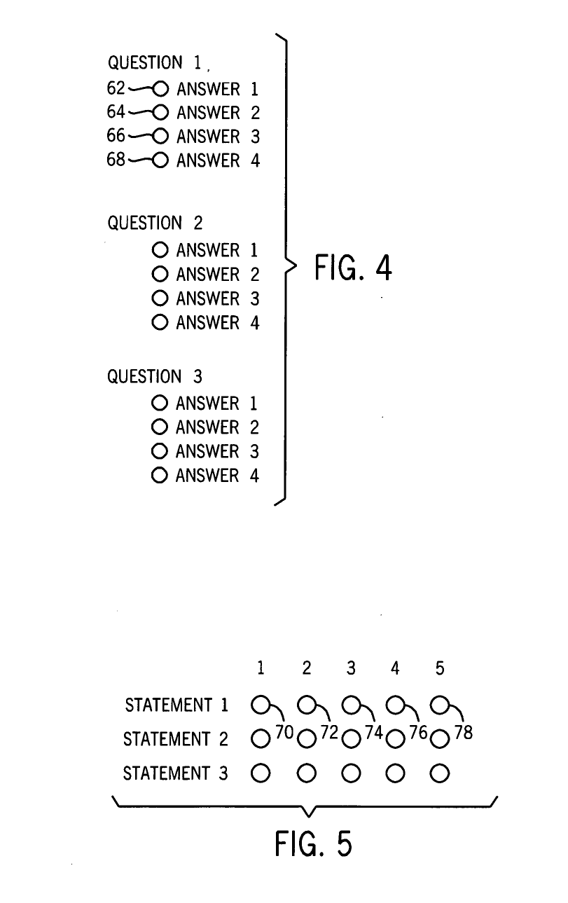

Block 60 performs an assessment of the user for attitude or state of mind. In one embodiment, the assessment is conducted on the computer system prior to the training session and stored for later use. Alternatively, the attitude assessment may be given in person or conducted through a written survey given off-line. The attitude assessment will be one or more measures within one or more sequences and presented as one or more computer screens of graphics, text, video, and audio. The attitude assessment may take the form of a series of questions after which the user selects one of several possible predetermined answers, see generally FIG. 4. For example, question 1 in the assessment may ask the user if he or she is accustomed to working with computers. The user will select from the predetermined answers 1-4 by checking or clicking on one of buttons 62, 64, 66, or 68. A positive answer or response indicates a comfort level with the computer; a negative answer or response indicates a reluctance to use computers for work-related activities. The user's answer forms a portion of the e-learning program's adaptive behavior to an optimal learning style for this particular person. In question 2, the attitude assessment may ask the user whether he or she believes the prior manufacturing tracking system is effective and user friendly. A positive response indicates the user may be hostile or at least reluctant to learning the new manufacturing tracking system. A negative response indicates the user is open and possibly even enthusiastic about the new system. The attitude assessment may ask the user whether he or she believes the new manufacturing tracking system will likely make their job easier to perform or be beneficial to the company. Again, a negative response indicates the user may be hostile or at least reluctant to learning the new manufacturing tracking system. A positive response indicates the user is open to learning the new system. The user's answers to each question forms the e-learning program's measure of the user's persona and drives the adaptive behavior to an optimal learning style for this particular person.

In addition to the question and answer form, the attitude assessment in block 60 may provide statements for which the user selects a scaled response. For example, the statement may ask the user whether he or she feels anxious about taking the time to learn a new system. The response can be a Likert scale ranging from 1 to 5, 1 representing “strongly disagree” to 5 representing “strongly agree,” see generally FIG. 5. The user will select one number from the 1-5 scale by checking or clicking on one of buttons 70, 72, 74, 76, or 78. The lower the response selected, the greater the challenge may be to convey the information in the e-learning program. Another statement may ask the user if he or she feels threatened by computers taking over jobs. The response can range from 1 representing “high concern” to 5 representing “no concern.” In this statement, the higher the selected response, the greater the likelihood that the user will absorb the material in the training program.

The specific questions presented in the attitude assessment can in part be dependent upon the answers given by the user to initial questions. If the user answers that he or she believes the prior system is effective and user friendly, the assessment will ask what features of the prior system the user likes best. If the user answers that he or she believes the prior system to be deficient, the assessment will ask what features of the prior system are problematic. If the user answers that he or she feels anxious about taking the time to learn a new system, the assessment will inquire into what is causing the anxiety.

The attitude assessment can delve into any number of questions, statements, observations, and queries that are relevant to the present task of learning and is intended to draw out the user's attitude, state of mind, and/or interest level in learning the new manufacturing tracking system. Ascertaining the user's attitude is important to formulating an approach that the e-learning program will undertake with the specific user. The results of the attitude assessment do not necessarily reveal all aspects of the person's psyche, but rather form a general evaluation of his or her willingness to participate in the program. The person's attitude is a significant factor in the program presentation and has a major impact on his or her conscious and subconscious ability to learn. One end user may look forward to the new tool that will make their job easier. Another user may fear or resent the software because of fear it may threaten job security or because of general apprehension of computers. Knowing the mental predisposition of the user toward both the expectation of the company in adopting the manufacturing tracking system as well as the requirement to undergo the e-learning program is key to designing an effective e-learning program.

Block 80 performs an assessment of the user for knowledge, competency, and experience. The knowledge assessment will be one or more measures within one or more sequences and presented as one or more computer screens of graphics, text, video, and audio. The knowledge assessment may take the form of a series of questions after which the user selects one of several possible predetermined answers, see generally FIG. 4. For example, the assessment may ask the user about his or her level of formal education. A college graduate is generally easier to teach new material to. Technically trained individuals are typically more comfortable with using unfamiliar computer software than are individuals from other educational disciplines. The knowledge assessment may ask the user about his or her tenure with the company. A person who has been with the company for considerable time will know its internal workings and see how the manufacturing tracking software fulfills those needs. The knowledge assessment may ask the user about his or her previous experience working with computers. A person who considers himself or herself to be computer savvy will be easier to train. The knowledge assessment may ask the user about his or her previous experience working with the manufacturing tracking system through other employers. A person who has been previously trained on the manufacturing tracking system may only have to sit through a short course directed to specific features used by the company or just a refresher course.

As discussed for the attitude assessment, the knowledge assessment in block 80 can provide statements for which the user selects a scaled response, see generally FIG. 5. For example, the statement may ask the user on a scale of 1-5 (1 being “low,” 5 being “high”) how knowledgeable he or she is about some company function, e.g., converting marketing projections and sales data to scheduling factory production orders. The lower the response selected, the greater the challenge will be to convey the material in the e-learning program. The higher the response, the more competent the user is with company procedures and operations, and the more likely the employee will be to absorb the training material. Another statement may ask the user if he or she has experience in other departments of the company. The response can range from 1 representing “no experience in other departments” to 5 representing “significant experience in other departments.” In this statement, the higher the selected response, the greater the likelihood that the user will absorb the material in the training program.

The specific questions presented in the knowledge assessment are in part dependent upon the answers given by the user to initial questions. If the user answers that he or she has a college degree, the assessment will ask in what discipline and graduation date. If the user answers that he or she has worked in other departments, the assessment will ask for details about the other job functions.

The knowledge assessment can delve into any number of questions, statements, observations, and queries that are relevant to the present task of learning and is intended to draw out the user's knowledge, competencies, and experience. Ascertaining the user's knowledge base is important to formulating an approach that the e-learning program will undertake with that specific user. The results of the knowledge assessment are not necessarily all encompassing, but rather form a general evaluation of the individual's ability to draw information from the program. The person's knowledge base is a significant factor in the program presentation and has a major impact on his or her ability to learn.

The above assessment represents only one embodiment of ascertaining a person's present state of mind and knowledge base. Other assessment approaches, including paper-based, live assessor, and separate software packages, are certainly within the scope of the present invention. Each of these assessment processes collects information about the mindset and knowledge base of the user.

From the information derived via orientation block 50, attitude assessment block 60, and knowledge assessment block 80, the e-learning program will create an evaluation, on a per user basis, indicative of his or her personal situation, attitudes, and knowledge base to make the training program more interesting, efficient, and effective. The evaluation may be a simple variable, e.g., threat level variable T or knowledge score variable K, or a table of assessments used by the e-learning program to make decisions as how to present the material to each end user. For example, the evaluation may classify the user as friendly (threat level T=0) or hostile (threat level T=100) from the attitude assessment. The evaluation may classify the user as expert (knowledge score K=100) or novice (knowledge score K<50) from the knowledge assessment. While these examples are high-level general classifications, the evaluation can create any level of detail in terms of classifying the user from the assessment data collected. The evaluation may classify the person as expert in manufacturing procedures or certain accounting functions. The evaluation may classify another person as lacking in basic computer skills or as having limited experience for job functions within his or her own department. The e-learning program will take all these evaluations into account when presenting the training material.

Continuing with FIG. 3, if the evaluation classified a particular user as hostile or apprehensive in terms of attitude, then the e-learning training program will begin with an attitude adjustment sequence. Those persons classified as hostile will undergo attitude adjustment sequence 90. Those persons classified as apprehensive will undergo attitude adjustment sequence 92. In other words, each person may have anxiety about the training program, but for different reasons. The attitude assessment has differentiated those feelings and directed the user to the appropriate attitude adjustment sequence to correct the problem. In an alternate embodiment, attitude adjustment sequences 90 and 92 may be combined into one sequence. In addition, some users may need to undergo both sequences. Those persons classified as friendly in terms of attitude will bypass attitude adjustment sequences 90 and 92 by path 94.

Attitude adjustment sequences 90 and 92 contain one or more measures designed to help the user understand the importance of the training program. Each measure will contain graphics, text, video, and audio to convey important information to help the user approach the training with the right mindset and otherwise help alleviate fears and concerns. The specific information within the attitude adjustment measure will, in part, depend upon the answers to the attitude assessment. If the user indicated hostility by answering that he or she feared losing their job because of the manufacturing tracking system, or had a dislike of computers in general, then the attitude adjustment measure could explain how jobs are generally not lost to computers, but rather that jobs will evolve to make use of each new business tool. The attitude adjustment measure within sequence 90 may explain that the best way to remain employed is to embrace new systems and learn to use them effectively. If the user indicated apprehension by answering that he or she did not like the prior system, but was not accustomed to working with computers, then the attitude adjustment measures within sequence 92 could walk the user through basic computer skills and help make the process fun and interesting and less intimidating.

Following attitude adjustment sequences 90 or 92, the user is given an attitude reassessment sequence 96. The attitude reassessment sequence 96 may be similar to attitude assessment 60 or may focus primarily on the goals of the attitude adjustment measures. If the user continues to have difficulty with his or her state of mind as to the manufacturing tracking system and/or e-learning training program, i.e., not right-minded yet, then the company may need to arrange for special help for this individual.

The process continues to the knowledge evaluation as shown in FIG. 3. The composite assessment of the user's knowledge may be converted to a knowledge score K ranging from 0-100. The user may have multiple knowledge scores for different areas, e.g., knowledge score for general computer knowledge, knowledge score for job function, knowledge score for applicable formal education, etc. End users having low knowledge score(s) are routed through preliminary training to correct the deficiency. Those persons classified with knowledge scores K<50 will undergo preliminary training sequence 98. Those persons classified with knowledge scores 50<K<75 will undergo preliminary training sequence 100. Those persons classified with knowledge scores 75<K<100 will bypass preliminary training sequences 98 and 100 by path 102. Thus, a knowledge score greater than a threshold of 75 will be considered acceptable for the main body of the e-learning program without preliminary training. The threshold is adjustable within the software.

Preliminary training sequences 98 and 100 contain one or more measures designed to help the user with basic technical comprehension needed to understand the subject matter of the training program. Each measure will contain graphics, text, video, and audio to convey such basic technical information. The specific information within the preliminary training measure will, in part, depend upon their answers to the knowledge assessment as well as their knowledge score. An end user with knowledge score K<50 needs more help than a user with knowledge score 50<K<75. The e-learning program will provide the necessary background information according to the knowledge score as derived from the knowledge assessment. Preliminary training sequence 100 provides the help for the users with knowledge scores 50<K<75; preliminary training sequence 98 provides the additional help for the users with knowledge scores K<50. For example, preliminary training sequence 98 may need to give the user basic computer skills such as how to use a keyboard and mouse, how to maneuver between screens, and how to enter data into a computer. Preliminary training sequence 100 may need to give the user basic information as to various job functions within the company for which the main body of the e-learning program will expand upon.

Following preliminary training sequences 98 or 100, the user is given a knowledge reassessment sequence 104. The knowledge reassessment sequence 104 may be similar to attitude assessment 80 or may focus primarily on the goals of the preliminary training measures. If the user continues to have difficulty with his or her knowledge base as to the manufacturing tracking system and/or e-learning training program, then the user is routed back through the preliminary training measures, or portions thereof which have not yet been grasped, or the employer may arrange for special help for this individual.

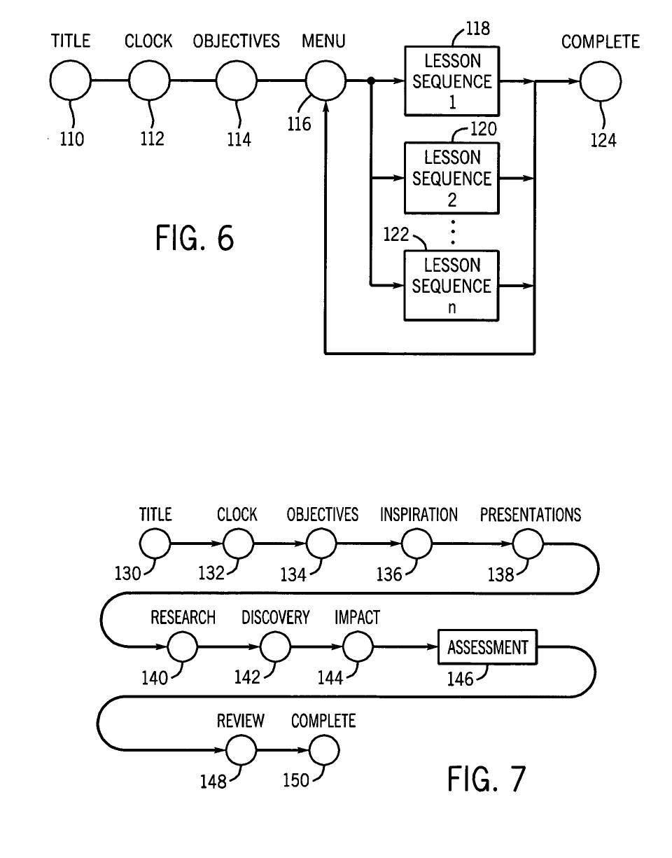

The e-learning program continues on to the formal training sequences in FIG. 6. The following discussion involves a simplified training sequence for ease of explanation and understanding. It is understood that e-learning system 10 can be used for more complex and multifaceted training programs.

The formal training begins with a title measure 110 to introduce the user to the program. Again, a measure contains the information to be displayed on a computer screen. The title measure 110 may contain a banner stating “Training Program for Manufacturing Tracking System.” The measure will contain supporting graphics, video, and audio/music for the introduction of the e-learning program. Clock measure 112 displays the estimated time of the forthcoming unit(s). Objective measure 114 displays the objectives of the unit(s) about to be covered, i.e., an overview of the coming material or topics. Menu measure 116 displays the lessons for the e-learning program. Menu measure 116 can show logical segments of the course, sequences involved, how to navigate within a course, etc. In this case, the e-learning program has “n” lessons available as lesson sequence 118, lesson sequence 120, and lesson sequence 122. Lesson sequences 118, 120, and 122 are assignable units or lessons in a learning plan. The user can select specific lessons to play, or the program may route the user through each lesson sequentially. Complete measure 124 completes the e-learning program.

Further detail of an exemplary lesson sequence is shown in FIG. 7. The lesson sequence is made up of a series of measures and sequences. Title measure 130 introduces the user to the lesson. Clock measure 132 displays the estimated time of the forthcoming unit or lesson. Objective measure 134 displays the objective(s) of the unit or lesson about to be covered, i.e., an overview of the coming material or topics. Inspiration measure 136 displays information to motivate and ground the user for the coming lesson.

Presentation measure 138 displays the subject matter which instructs the user on the operation and function of particular features of the manufacturing tracking system. Presentation measure 138 contains graphics, text, audio, and video to convey some portion of the core training material for the e-learning program to the user. For example, the presentation measure may demonstrate how to enter data, run reports, select options, investigate trends, analyze problems, plan production schedules, determine yields, perform failure analysis, track shipments, maintain customer information, and otherwise make use of the manufacturing tracking system.

Additional presentation measures can be inserted after measure 138 to provide more information to the user about the system. Each presentation measure is customized to the user. As further discussed below, the e-learning program makes decisions, based on its assessment of the user, about which presentation measures to display and how to display each presentation measure. Some users will see some presentation measures, but not others; some presentation measures may be skipped; some users will see a truncated version of the presentation measure; some users will see an expanded version of the presentation measure; some presentation measures may be substituted for other presentation measures—all based on the user assessments.

Research measure 140 is a hands-on activity used as a teaching aid that causes the user, based on the presentation just made, to gather additional information. The research activity causes the user to explore on their own and is intended to solidify the presentation as well as expound upon the new found knowledge. For example, the user may be given a problem and must gather information from various resources, e.g., the Internet, to solve the problem. Discovery measure 142 then uses the information gathered from the research measure 140 to solve the problem using the manufacturing tracking software.

Impact measure 144 displays the results of the research and discovery measures. The impact measure is a “eureka” moment which emphasizes how the user has successfully solved a problem using the manufacturing tracking system. The impact measure is a positive experience in the training program and is intended to help the user understand the benefits to be realized from his or her efforts and to reinforce their commitment to learn the system.

Assessment sequence 146 presents a series of question measures to confirm the user has indeed mastered or at least comprehended the subject matter of the previous lesson measures. The questions can be true/false, multiple choice, and matching. The user could be asked to perform certain tasks with the manufacturing tracking software to test his or her new-found competency with the system. The assessment is checked against the objectives to confirm the effectiveness of the e-learning program. Assessment sequence 146 can be used to update the assessment table created in the initial assessment. Review measure 148 provides feedback to the user on his or her performance on the lesson and makes suggestions for further review. For example, the user may be guided to external references, e.g., white papers, websites, etc. for more information. Complete measure 150 completes the lesson sequence.

Other types of measures include splash measure, game/puzzle measure, role play measure, illustration/application measure, simulation measure, survey measure, resource measure, and transition measure, each providing specific purposes within the training program.

Based on the assessment sequence 146, the user can be routed back to the same lesson sequence or another lesson sequence depending on what the user needs to continue the training, i.e.,more review and training, or demonstrate readiness for the next lesson sequence on another topic.

A principal feature of the present invention is the ability of the e-learning program to automatically customize or alter the presentation to the needs of each user. Learning must be done in an appropriate context for the user. A one-size training program does not fit all users. The assessment and real-time responses from the users allow the e-learning program to alter its presentation of the course subject matter. Each user will view a different course, customized to his or her needs. The e-learning program provides a seamless experience that omits or truncates certain subject matter areas and emphasizes other areas. Some measures will contain special motifs to aid in the understanding and comprehension of the course subject matter. The decision as to which presentation measures and what portions of a presentation measure a particular user will see is dependent on the assessments discussed above. The concept of sequences and measures provides the modularity to the e-learning program that allows the adaptability and customization of the presentation to the user. The logic necessary to adapt the training methodology to fit each user is an integral part of the e-learning program. This logic is implemented in the software code executing on the computer system in the form of a set of rules, established by the program developer, that receives input from the user assessment and makes decisions about the presentation of the program to the user.

The e-learning program maintains an ongoing assessment table or set of variables or thresholds that are set during the initial assessment, but can be updated from the assessments, reviews, and feedback received during the lesson sequences. The assessment table forms the logical checks and determinations that will display certain information and not display other information. According to the rule structure, if the user needs more information based on the assessment table, then that information is provided. If the user needs less information based on the assessment table, then that information is omitted or truncated.

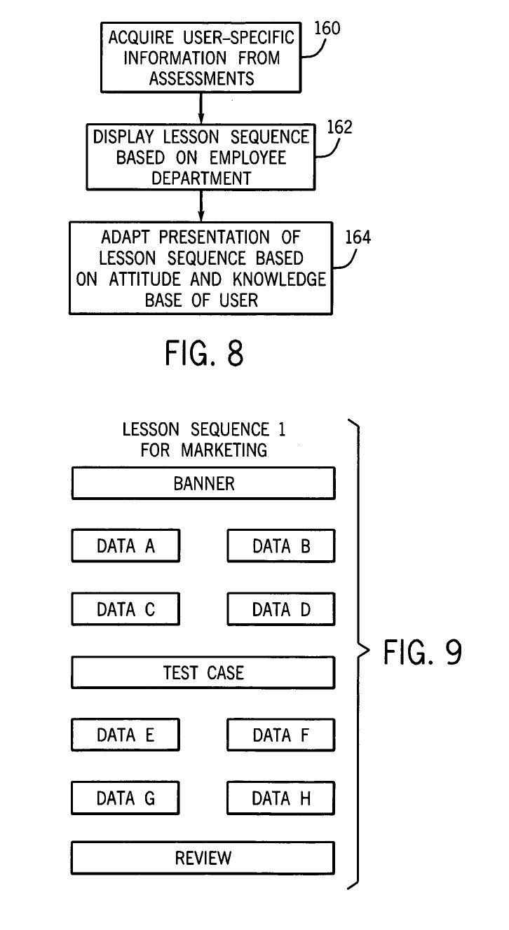

Consider the logical flowchart shown in FIG. 8. The flowchart is a simplified example to illustrate the essential features of the adaptive e-learning program. Block 160 acquires user-specific information, e.g., personal data, assigned department within the company, general attitude toward the present training process, general knowledge base, work experience, etc., from the assessments. Block 162 determines which department the user is assigned to and calls up the appropriate lesson sequence. Recall that the course development involved ascertaining which portions of the manufacturing tracking system are applicable to the users on a departmental basis. If the user is assigned to engineering, he or she will see the lesson sequence for engineering department users; if the user is assigned to marketing, he or she will see the lesson sequence for marketing department users; if the user is assigned to management, he or she will see the lesson sequence for management users, and so on. In block 164, the e-learning program adapts the presentation of the lesson sequence to the attitude and knowledge base assessments of the specific user. For example, if the user is viewing the lesson sequence for marketing users and the user is apprehensive about using computers, or lacking some knowledge component, then the e-learning program will customize the lesson sequence for those needs. The presentation measures for the subject matter of the manufacturing tracking system may present more basic information, using simple terminology, and will go through more steps than would have been the case for a computer savvy user. The threat level T and knowledge score K are used to by the rule structure to automatically select portions of measures to be displayed, truncated, expanded, or omitted. The various measures within the lesson sequence will provide positive feedback to give the user confidence in his or her progress.

FIG. 9 illustrates a simplified presentation measure within the lesson sequence 1 for the apprehensive marketing user. The presentation measure for the lesson sequence 1 contains a banner, data blocks A-D, test case, data blocks E-H, and then a review. The data blocks can be any information to be conveyed to the user. For example, data blocks A-D may describe how to run a report. Data blocks E-H may explain how to analyze the data from the report. The test case provides an illustration of the data blocks. The presentation measure of FIG. 9 shows just a few of the types of selections and information that can be made available to the user. An actual commercial website or software user interface will include more in the way of graphics, drawings, text, instructions, marketing, color, audio, music, and appeal.

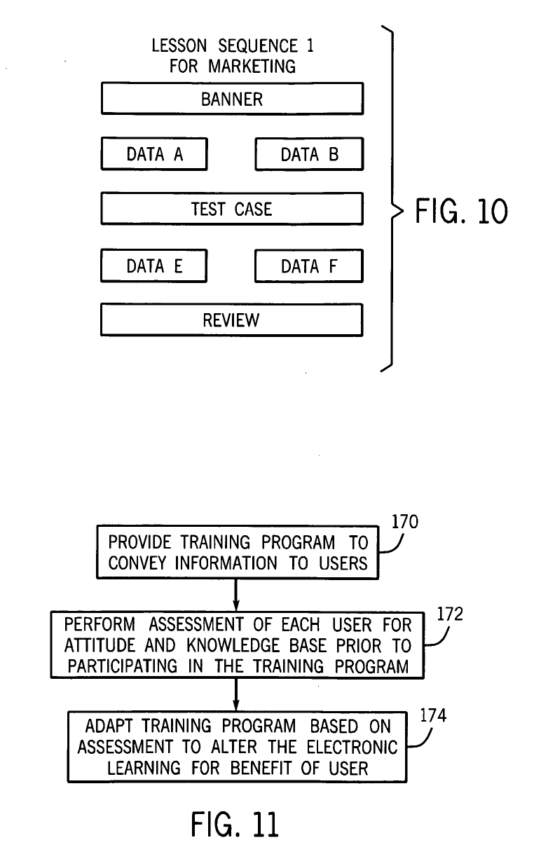

Alternatively, if the marketing user is a sophisticated computer user, or has prior knowledge about the manufacturing tracking system, the presentation measures will proceed with a truncated version, much more rapidly, so as not to lose the user's attention. FIG. 10 illustrates a simplified presentation measure within the same lesson sequence 1 for the sophisticated marketing user. The user sees only data blocks A-B and E-F. The truncation of the lesson sequence 1 between FIGS. 9 and 10 occurred automatically by the e-learning program according to the rule structure based on the user assessment. Again, the threat level T and knowledge score K are used to automatically select portions of measures to be displayed, truncated, expanded, or omitted. The more advanced user does not need to see data blocks C-D and G-H, so they are omitted from the presentation.

In other examples, the e-learning program will expand the lesson sequence, beyond that of a typical user, for those people needing even more help with the subject matter of the training program. The e-learning program may launch a tutorial on navigating through the “Windows” environment to help some users. The e-learning program may display basic accounting principles or manufacturing process flows for those failing to understand these fundamentals to the manufacturing tracking system. The e-learning program may explain the company's purpose for adhering to some government-imposed reporting procedures if the user is unfamiliar with these requirements. The e-learning program may explain links between departments if the user needs to know this information.

In any case, the e-learning program continuously reviews the user information created during the initial assessment and adapts the presentation to help the user get maximum results from the training. The e-learning program customizes its presentation using the attitude and knowledge base scores, challenges the user's interest with research and discovery measures, emphasizes successes with the impact measure, tests understanding with the assessment measures, and provides feedback with the review measures. Each user could potentially see a different training program—all dependent on his or her assessment within the rule structure. Moreover, the assessments conducted during the lesson sequences provide further information as to how the user is progressing. The e-learning program will adapt its pace and presentation to how fast or slow the user is moving through the program, how well he or she is comprehending the subject matter, and even accounts for changes in the user's attitude during the program. If the user becomes bored or frustrated during the training presentation, the e-learning program can adapt and provide more or less information. The e-learning program can even suggest the user take a break, if things are not going well, to regain perspective.

The modularity of the e-learning program, as provided by the sequences and measures described above, aids in the development of a particular training program. Each portion or segment of the measures is logically checked against the assessment table to determine what should be displayed for the present user. Before each measure is displayed, and before features within a measure are displayed, the e-learning program performs a rule check against the user assessment data to determine what is the optimal presentation for the user. If the rule check finds the user needs more or less information, then an adjustment is made to the measure presentation accordingly. This feature makes the e-learning program relatively easy to develop and yet adaptive for the user.

The course developer defines the rules by which the assessment information is used to cause the user to see certain information and not other information, or to be routed to one lesson sequence versus another lesson sequence. The software code within the training program will examine the thresholds of the assessment table and, if indicated within the rule structure, display the relevant portion of the sequence or measure, or route the user to the appropriate place in the program. For example, one rule might state that a portion of a presentation measure may be displayed if K<50, but omitted if K>75. Another rule might state that a portion of inspiration measure may be displayed if T<50, but not T>80. Instead, according to the rule structure, another portion of the inspiration measure is displayed if T>80. These examples are provided for illustrative purposes. The specific rule checks and determinations within the e-learning program are dependent on the training program being developed and course design choice. The rules set by the program developer as played against the assessment table are what causes the e-learning program to adapt to the user's needs and become unique for each user.

The unique characteristics of each type of measure is embodied in its file structure. A Flash file is a small computer applet that is hosted within the main program and provides the measure's functionality. A Style Sheet file defines the visual characteristics of the measure. An XML Schema file defines the characteristics of the information (content) that will be conveyed by the measure. An XML file contains the actual information that will be displayed to the user in each instance where the measure is used. The Flash file, Style Sheet file, and XML Schema file are unique to each measure. The XML file is unique to each instance where the measure is used. By way of example, suppose that there is a measure called “LessonMenu” that is used at the beginning of each lesson and allows the user to select the particular topic within the lesson that the user wants to explore. For the entire program, there would be one of each of the first three files. But if the measure were used in three lessons, there would be three instances of the last file, each carrying unique information about that particular use of the measure.

As further explanation, FIG. 11 illustrates a process flowchart of one embodiment of the e-learning program. In step 170, a training program is provided to convey information to users. The training program uses a plurality of sequences, and a plurality of measures within the sequences. In step 172, an assessment of each user for attitude and knowledge base is performed prior to participation in the training program. The attitude assessment solicits responses from each user as to his or her state of mind regarding the training program. The knowledge base assessment solicits responses from each user to test his or her understanding of subject matter related to the training program. The responses to the assessment are then stored for use in determining individualized presentation of material in the training program. In step 174, the training program is adapted based on the assessment to alter the electronic learning for the benefit of the user. A first or second measure is selected for presentation to the user based on the assessment. The first measure is a different level of detail than the second measure of similar subject matter. The first measure is displayed if a knowledge factor is greater than a threshold, and the second measure is displayed if the knowledge factor is less than the threshold. The first measure is displayed if a threat level is greater than a threshold, and the second measure is displayed if the threat level factor is less than the threshold. The assessment is updated during the training program based on the progress of the user.

There are a number of tools which aid in developing the training program. In one embodiment, the sequence and measures within FIGS. 6 and 7 can be shaped or color coded for emotional impact. Hot colors, such as red and pink, indicate high emotional impact or engaging content, requiring a high level of thought and focus. Cool colors, such as blue and green, indicate low emotional impact or passive experience, requiring a low level of thought and focus. If the user is subjected to too much or too lengthy hot-colored sequences or measures without a break, the user may become fatigued. If the user is subjected to too much or too lengthy cool-colored sequences or measures, the user may become disinterested. The hot-colored and cool-colored sequences and measures should be intermixed and balanced to keep the emotional content cycling from high to low. With the color-coded sequences and measures, the course designer can visually balance and vary the emotional content of the course. Visually mapping the intensity of the course will help in the development of the e-learning program. The user will enjoy the program more and will comprehend and retain more of the course subject matter.

Another tool helpful in course development is a temporal map of the training program. The sequence and measures of FIGS. 6 and 7 are spaced apart or color coded to indicate the length of time each sequence or measure requires to complete. This is known as pacing. Having the ability to display the temporal relationship between the sequences and measures enables the developer to establish and vary rhythms within the course to ensure that the course is neither monotonous nor randomly arrhythmic. Displaying the temporal relationships also helps coordinate the course objectives with development costs. Mapping the timing of the e-learning program is important in determining course content, development costs, and providing an accurate time for the course as a whole to be completed.

As indicated previously, a key concept in human learning is recursiveness. Humans learn best when knowledge is distilled to relatively few messages, or leitmotifs, which are interwoven and recursed throughout the training program. This provides the intellectual framework, or pattern, which the learner assimilates. Additional information is then tied to the leitmotifs, making it easier for the user to assimilate and retain over time. The tool provides the ability for the developer to establish leitmotifs, track their use throughout the program, and vary their intensity. By monitoring and controlling the intensity and pacing together in support of the leitmotifs, the developer can ensure that the user better understands and assimilates key messages and retains associated information and skills.

A color coding scheme can also be used to track budget on the module development. Higher budget allocated modules are given a different color code than lower budget allocated modules. The developer can keep track of time spent on module development by way of the color coding scheme.

Another color coding scheme enables groups of developers working collaboratively to monitor the development of the measures and sequences of the course as it progresses through stages of production to completion.

A visual path manager allows the program developer to design the course by dragging nodes (measures/sequences) onto a visual canvas. The visual path manager operates along three axis and provide encapsulation. The visual path manager allows the program developer to establish business rules for the connections between nodes and inspect those rules simply by rolling the mouse over the connection.

The e-learning program described above offers a number of advantages. The company should receive a high return on its investment. The money spent on the present e-learning program will provide good results, i.e., convey the information to employees on how to use the manufacturing tracking system. The results are confirmed with the assessment and feedback received by each user. The good result arises from the custom presentation available for each user, wherein the training program is adaptive to their specific needs.

While one or more embodiments of the present invention have been illustrated in detail, the skilled artisan will appreciate that modifications and adaptations to those embodiments may be made without departing from the scope of the present invention as set forth in the following claims.

What is claimed is:

1. A method of providing an electronic learning program, comprising:
providing a training program to convey information to users;
performing an assessment of each user for attitude and knowledge base prior to participation in the training program; and
adapting the training program based on the assessment to alter the electronic learning for benefit of the user.

2. The method of claim 1, wherein the training program includes a plurality of sequences and a plurality of measures within the sequences.

3. The method of claim 2, wherein the plurality of measures is organized for specific purposes within the training program.

4. The method of claim 2, wherein the plurality of measures is selected from the group consisting of title measure, clock measure, objective measure, menu measure, inspiration measure, presentation measure, research measure, discovery measure, impact measure, assessment measure, review measure, splash measure, game/puzzle measure, role play measure, illustration/application measure, simulation measure, survey measure, resource measure, transition measure and complete measure.

5. The method of claim 1, wherein the assessment for attitude solicits responses from each user as to state of mind regarding the training program.

6. The method of claim 5, wherein the assessment for knowledge base solicits responses from each user to test understanding of subject matter related to the training program.

7. The method of claim 6, wherein the responses to the assessment are stored for use in determining presentation of material in the training program.

8. The method of claim 1, wherein a first or second measure is selected for presentation to the user based on the assessment, the first measure being a different level of detail than the second measure of similar subject matter.

9. The method of claim 8, wherein the first measure is displayed if a knowledge factor is greater than a threshold, and the second measure is displayed if the knowledge factor is less than the threshold.

10. A method of adapting presentation of an electronic learning program, comprising:
providing a training program to convey information to a user;
performing an assessment of the user; and
adapting the training program based on the assessment to alter presentation of the training program for benefit of the user.

11. The method of claim 10, wherein the training program includes a plurality of sequences and a plurality of measures within the sequences.

12. The method of claim 11, wherein the plurality of measures is organized for specific purposes within the training program.

13. The method of claim 11, wherein the plurality of measures is selected from the group consisting of title measure, clock measure, objective measure, menu measure, inspiration measure, presentation measure, research measure, discovery measure, impact measure, assessment measure, review measure, splash measure, game/puzzle measure, role play measure, illustration/application measure, simulation measure, survey measure, resource measure, transition measure and complete measure.

14. The method of claim 10, wherein the assessment tests for attitude and knowledge base of the user.

15. The method of claim 14, wherein the assessment for attitude solicits responses from the user as to state of mind regarding the training program.

16. The method of claim 15, wherein the assessment for knowledge base solicits responses from the user to test understanding of subject matter related to the training program.

17. The method of claim 10, wherein the responses to the assessment are stored for use in determining presentation of material in the training program.

18. The method of claim 10, wherein a first or second measure is selected for presentation to the user based on the assessment, the first measure being a different level of detail than the second measure of similar subject matter.

19. The method of claim 18, wherein the first measure is displayed if a knowledge factor is greater than a threshold, and the second measure is displayed if the knowledge factor is less than the threshold.

20. The method of claim 18, wherein the first measure is displayed if a threat level is greater than a threshold, and the second measure is displayed if the threat level factor is less than the threshold.

21. The method of claim 10, wherein the assessment is updated during the training program based on progress of the user.

22. A computer program product usable with a programmable computer processor having a computer readable program code embodied therein, comprising:
computer readable program code which provides a training program to convey information to a user;
computer readable program code which performs an assessment of the user; and
computer readable program code which adapts the training program based on the assessment to alter presentation of the training program for benefit of the user.

23. The computer program product of claim 22, wherein the assessment tests for attitude and knowledge base of the user.

24. The computer program product of claim 22, wherein a first or second measure is selected for presentation to the user based on the assessment, the first measure being a different level of detail than the second measure of similar subject matter.

25. The computer program product of claim 22, wherein the first measure is displayed if a knowledge factor is greater than a threshold, and the second measure is displayed if the knowledge factor is less than the threshold.

26. A computer system for adapting presentation of an electronic learning program, comprising:
means for providing a training program to convey information to a user;
means for performing an assessment of the user; and
means for adapting the training program based on the assessment to alter presentation of the training program for benefit of the user.

27. The computer system of claim 26, wherein the assessment tests for attitude and knowledge base of the user.

28. The computer system of claim 26, wherein a first or second measure is selected for presentation to the user based on the assessment, the first measure being a different level of detail than the second measure of similar subject matter.

29. The computer system of claim 26, wherein the first measure is displayed if a knowledge factor is greater than a threshold, and the second measure is displayed if the knowledge factor is less than the threshold.

30. A method of developing an electronic learning program, comprising:
providing a training program to convey information to a user;
coding modules of the training program based on emotional content of the information as conveyed to the user; and
spacing the modules of the training program based on the coding to balance impact of presentation of the information on the user.

31. The method of claim 30, wherein the coding uses color to differentiate emotional content of the information as conveyed to the user.

32. The method of claim 30, further including providing temporal information of each module to assist in development of the training program.
